(19) United States
(12) Patent Application Publication
(10) Pub. No.: US 2007/0073914 A1
(43) Pub. Date: Mar. 29, 2007

(54) WIRELESS COMMUNICATION APPARATUS AND CONTROL METHOD OF THE APPARATUS

(75) Inventor: Masashi Yoshida, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/469,989

(22) Filed: Sep. 5, 2006

(30) Foreign Application Priority Data
Sep. 13, 2005 (JP) 2005-265925

(51) Int. Cl. G06F 3/00

(52) U.S. Cl. 710/10

(57) ABSTRACT

A wireless communication apparatus having first wireless settings includes a search unit which searches for a device which has second wireless settings corresponding to the first wireless settings, and a control unit which controls the wireless communication apparatus. If the device is found by the search unit and the device has not created an ad-hoc network, the wireless communication apparatus creates an ad-hoc network which includes the device. Further, if the device is found by the search unit and an ad-hoc network has been created by the device, the wireless communication apparatus joins the ad-hoc network which has been created by the device.

### BACKGROUND OF THE INVENTION

1. Field of the Invention

The present invention relates to a wireless communication apparatus configured to perform wireless communication through an ad-hoc network, and a method of controlling the apparatus.

2. Description of the Related Art

In wireless LANs, there are two kinds of connection modes, an infrastructure network and an ad-hoc network. In the infrastructure network, when terminal devices communicate with each other, an access point is necessary to transmit and receive data, where communication is performed under packet control at the access point.

In the infrastructure network mode, when a terminal device is connected to an infrastructure network, a probe request querying whether any wireless network exists around the network is issued between the terminal device and the access point, and an authentication request for executing authentication of the terminal device is carried out. Further, an association request for executing a connection request is issued to establish a wireless connection between the terminal device and the access point.

On the other hand, the ad-hoc network is a wireless network in which terminal devices communicate directly with each other without the use of an access point. When a terminal device is connected to an ad-hoc network, the authentication request and the association request are not made, and only a search of wireless networks around the ad-hoc network is carried out. To carry out the wireless network search, wireless parameters of the wireless network that can be connected are sent as a probe request.

In wireless LANs, there are two scan modes: active scan mode and passive scan mode. In an active scan mode, a probe response from a device that can be connected is waited for. In a passive scan mode, a beacon, which includes wireless parameters of the wireless network that can be connected, is monitored for a predetermined period of time.

In the case of performing a wireless network search to connect a device to a wireless network, if an ad-hoc network that can be connected to is found, the device will join the network. If an ad-hoc network that can be connected to can not be found, the device itself creates an ad-hoc network for the purpose of creating an ad-hoc network. For example, in Japanese Patent Application Laid-open No. 2004-104788, an apparatus and a method for quickly and effectively establishing a user-friendly ad-hoc network are proposed.

With respect to network identifiers of wireless LANs, ESSID (Extended Service Set Identification) and BSSID (Basic Service Set Identification) are provided. The ESSID is used when a user identifies a wireless network. On the other hand, the BSSID is used when a wireless communication unit actually identifies the wireless network.

With reference to FIG. 5, a procedure of creating an ad-hoc network is described below. Here, a case is described in which multiple wireless communication devices (A and B) start ad-hoc network connections at the same time, with the same wireless parameters (the same ESSID and the same channel) (steps 501 and 502). In this case, each wireless communication device carries out a peripheral wireless network search (Probe Request) at the same time (steps 503 and 504).

At this stage, there is no ad-hoc network. Accordingly, no response (Probe Response) can be obtained from either device. Then, each wireless device creates its own ad-hoc network (steps 507 and 508). More specifically, each device creates ad-hoc networks A and B with BSSIDs which are unique to each of the devices. Therefore, each device exists in different ad-hoc networks and cannot communicate with each other.

If a device cannot find a wireless network that can be connected and creates its own ad-hoc network, the device has to expend power sending synchronization signals (beacons) even if there is no device to communicate with.

### SUMMARY OF THE INVENTION

The present invention is directed to overcome the above-described drawbacks and disadvantages. For example, the present invention is directed to a system in which multiple wireless communication devices start ad-hoc network connections at the same time and each of the wireless communication devices can be connected to the same ad-hoc network.

According to an aspect of the present invention, a wireless communication apparatus having first wireless settings includes a search unit which searches for a device which has second wireless settings corresponding to the first wireless settings, and a control unit which controls the wireless communication apparatus. If the device is found by the search unit and the device has not created an ad-hoc network, the control unit controls the wireless communication apparatus to create an ad-hoc network which includes the device and the wireless communication apparatus. Further, if the device is found by the search unit and the device has created an ad-hoc network, the control unit controls the wireless communication apparatus to join the ad-hoc network which has been created by the device.

According to another aspect of the present invention, a wireless communication apparatus having first wireless settings includes a search unit which searches for a device which has second wireless settings corresponding to the first wireless settings, and a control unit which controls the wireless communication apparatus. If the device is found by the search unit, the control unit controls the wireless communication apparatus to create an ad-hoc network which includes the device and the wireless communication apparatus. Further, if the device is not found by the search unit, the control unit controls the search unit to continue to search for the device which has the second wireless settings.

Further embodiments, aspects and features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate numerous embodiments, features and aspects of the invention and, together with the description, serve to explain the principles of the invention.

FIG. 1 illustrates a wireless communication system according to a first exemplary embodiment of the present invention.

FIG. 2 illustrates a configuration of a digital camera according to the first exemplary embodiment of the present invention.

FIG. 3 illustrates a configuration of a wireless adapter according to the first exemplary embodiment of the present invention.

FIG. 4 illustrates a configuration of a printer according to the first exemplary embodiment of the present invention.

FIG. 5 illustrates a sequence at the time of an ad-hoc network creation.

FIG. 6 illustrates an operation flow according to the first exemplary embodiment of the present invention.

FIG. 7 illustrates an operation flow according to a second exemplary embodiment of the present invention.

FIG. 8 illustrates a wireless communication system according to the second exemplary embodiment of the present invention.

### DETAILED DESCRIPTION OF THE EXEMPLARY EMBODIMENTS

Various exemplary embodiments, features, and aspects of the present invention will now be herein described in detail below with reference to the drawings.

### First Exemplary Embodiment

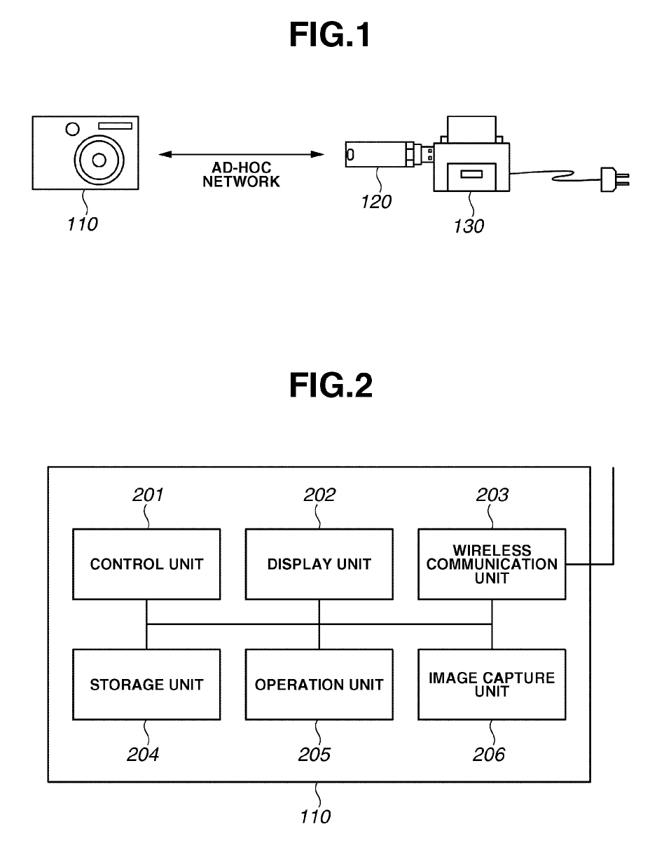

FIG. 1 illustrates a wireless communication system according to a first exemplary embodiment of the present invention. The wireless communication system includes a printer 130, a digital camera 110 which works as an image capturing device having a wireless communication function, and a wireless adapter 120. The wireless adapter 120 is connected with the printer 130 via an USB (Universal Serial Bus), and connected with the digital camera 110 through a wireless LAN. The wireless adapter 120 converts protocols between the USB and the wireless LAN. In this exemplary embodiment, a wireless LAN compliant with the IEEE 802.11a/b/g etc. can be used. The printer 130 is powered by an AC power source or by an electric power supplied by a battery mounted on the printer 130. The digital camera 110 is powered by an AC power source or by an electric power supplied by a battery mounted on the digital camera 110. The wireless adapter 120 is powered by an electric power (bus power) supplied by the USB. That is, the wireless adapter 120 is a bus-powered device.

FIG. 2 illustrates a configuration of the digital camera 110 according to the first exemplary embodiment of the present invention. The digital camera 110 includes a control unit 201, a display unit 202, a wireless communication unit 203, a storage unit 204, an operation unit 205, and an image capture unit 206. The control unit 201 controls the entire digital camera 110. The display unit 202 displays a menu and the like. The wireless communication unit 203 allows the digital camera 110 to wirelessly communicate with other wireless communication devices, e.g., printer 130. The storage unit 204 stores wireless parameters and various data. The operation unit 205 carries out various operations such as mode selection, mode decision, image capturing operation, etc. according to a user operation. The image capture unit 206 captures images.

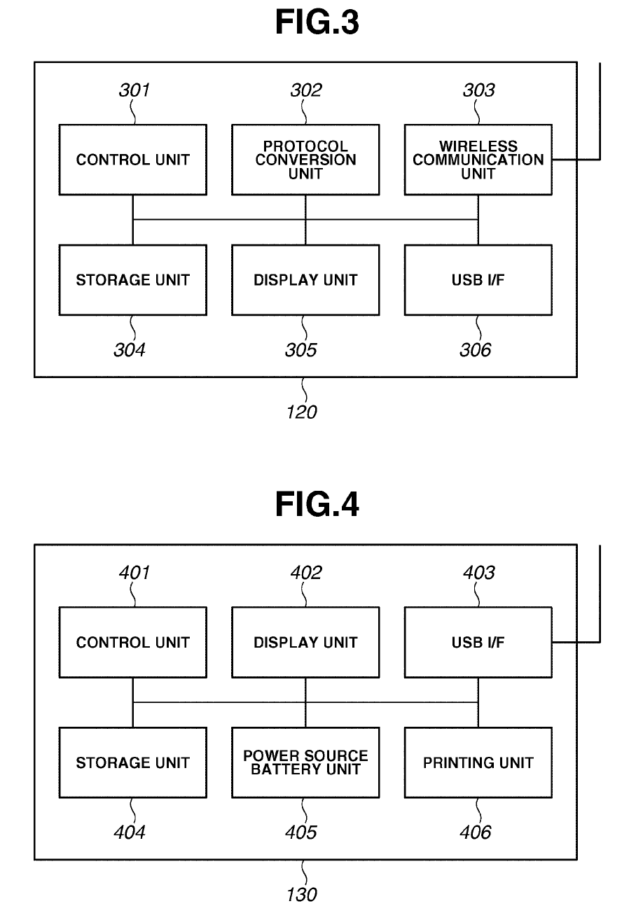

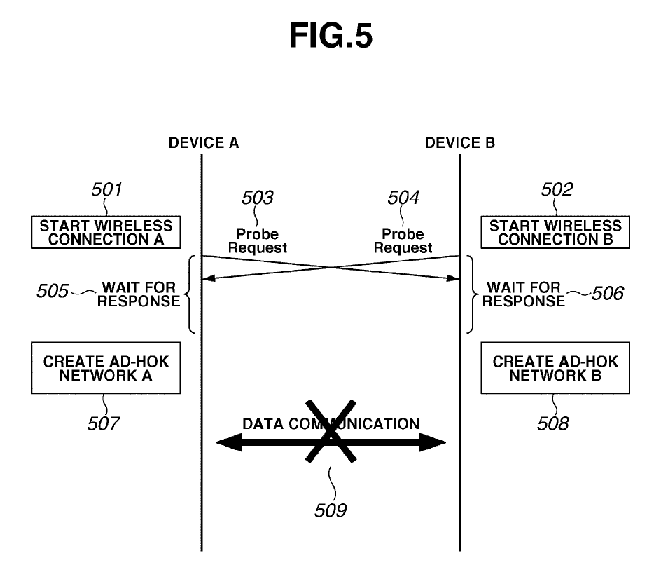

FIG. 3 illustrates a configuration of the wireless adapter 120 according to the first exemplary embodiment of the present invention. The wireless adapter 120 includes a control unit 301, a protocol conversion unit 302, a wireless communication unit 303, a storage unit 304, a display unit 305, and an USB interface 306. The control unit 301 controls the entire wireless adapter 120. The protocol conversion unit 302 converts protocols between the USB and a wireless LAN. The wireless communication unit 303 allows the wireless adapter 120 to wirelessly communicate with other wireless communication devices, e.g., digital camera 110. The storage unit 304 stores various parameters, including wireless parameters. The display unit 305 displays status of the wireless adapter 120. When the wireless adapter 120 is connected to the printer 130, the wireless adapter 120 is powered by the printer 130 and functions as a USB device. The printer 130 can also function as a USB host. The wireless adapter 120 can also be configured by a dongle which has a wireless communication function. Further, the wireless adapter 120 can be built into the printer 130. In such a case, the wireless communication system according to this exemplary embodiment includes the digital camera 110 and the printer 130 in which the wireless adapter 120 is contained.

FIG. 4 illustrates a configuration of the printer 130 according to the first exemplary embodiment of the present invention. The printer 130 includes a control unit 401, a display unit 402, a USB interface 403, a storage unit 404, a power battery unit 405, and a printing unit 406. The control unit 401 controls the entire printer 130. The display unit 402 displays a status of the printer 130. The storage unit 404 stores various parameters and print data. The power battery unit 405 manages an AC power source and a battery. The printing unit 406 carries out print processing.

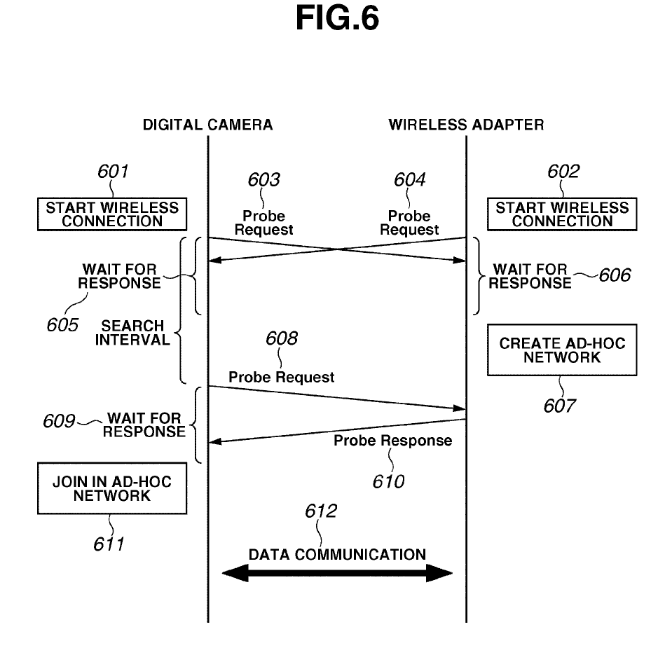

FIG. 6 illustrates a sequence of processing according to the first exemplary embodiment of the present invention. In the first exemplary embodiment, the digital camera 110 and the wireless adapter 120 constitute an ad-hoc network. The first exemplary embodiment relates to a sequence carried out in a wireless connection when a direct printing is executed between the digital camera 110 and the printer 130 through the wireless adapter 120. More particularly, it relates to a sequence carried out when an ad-hoc network is established.

Each wireless communication device in this system is divided into two types: a wireless communication device equipped with the ad-hoc network establishing function or a wireless communication device not equipped with the ad-hoc network establishing function. In the present exemplary embodiment, the wireless communication device equipped with the ad-hoc network establishing function is referred to as a wireless communication device with creator function.

If a wireless communication device with creator function creates an ad-hoc network and the wireless communication device exists by itself in the network, the wireless communication device has to regularly send a beacon signal, which is a synchronization signal for wireless communication devices that later attempt to join the network. Accordingly, the wireless communication device consumes electric power even when it is not carrying out wireless communication.

In this system, in consideration of the electric power supply methods of each wireless communication device, at the time of wireless parameter setting, a user designates a wireless communication device in the wireless system as a wireless communication device equipped with creator function and the other wireless communication devices are designated as wireless communication devices not equipped with creator function.

In the wireless system according to the first exemplary embodiment, the wireless adapter 120, which is always supplied with electric power by the printer 130, is designated as the wireless communication device equipped with creator function. The battery-powered digital camera 110 is designated as the wireless communication device not equipped with creator function at the time of parameter setting.

With reference to FIG. 6, specific operation according to the first exemplary embodiment will be described. More specifically, in FIG. 6, a case is described in which wireless connections (steps 601 and 602) are started at the same time by the digital camera 110 and the printer 130 with the wireless adapter 120.

The wireless adapter 120 can start the wireless connection when the wireless adapter 120 is connected to the printer 130 via the USB, or after an instruction is given by a user (step 602). The digital camera 110 starts the wireless connection after a user operates the operation unit 205 of the digital camera 110 to give an instruction to start the wireless connection (step 601).

When the wireless connections are started, both the wireless communication unit 203 of the digital camera 110 and the wireless communication unit 303 of the wireless adapter 120 send a probe request packet to search for peripheral wireless networks (steps 603 and 604), and wait for the responses (Probe Response)(steps 605 and 606) from any peripheral wireless networks while in a stand-by mode.

When the digital camera 110 and the wireless adapter 120 receive probe responses while in the response waiting state (steps 605 and 606), the wireless communication device which sent the probe response is connected (joins) to the ad-hoc network. If the probe responses are not received while in the response waiting state (steps 605 and 606), each wireless communication device operates respectively as described below.

Because the wireless adapter 120 has the creator function, if the probe response is not received while in the response waiting state (steps 605 and 606), the wireless adapter 120 itself creates an ad-hoc network (step 607) and starts to send a beacon signal.

On the other hand, because the digital camera 110 is not equipped with the creator function, the digital camera 110 does not create an ad-hoc network. After a search interval waiting for the responses after the transmission of the previous probe request, the digital camera 110 sends another probe request (step 608). The transmission is repeated until, in the search of peripheral wireless network, an ad-hoc network is found to which the digital camera 110 can be connected.

After the probe request is sent (step 608), while in the response waiting state (step 609), the digital camera 110 receives a probe response from the wireless adapter 120 (step 610). The digital camera 110 then joins the ad-hoc network created by the wireless adapter 120 (step 611) and the wireless connection is established (step 612).

The search interval is longer than the response waiting time (step 605). When the digital camera 110 is not waiting for the response (step 605), the digital camera 110 can reduce electric power consumption by transferring to a power-saving mode.

Once a wireless connection between the digital camera 110 and the wireless adapter 120 is established, the digital camera 110 is connected to the printer 130 via the wireless adapter 120 and direct printing can be carried out.

If there are a plurality of wireless communication devices which are equipped with a valid creator function in the wireless system, even after the wireless network is established, the search of peripheral networks is regularly carried out. When networks which have the same wireless parameters are detected in the search, the established wireless network is abandoned and a connection is made to the network detected by the search. Thus, the digital camera 110 and the wireless adapter 120 can be connected to the same ad-hoc network, and the digital camera 110 and the wireless adapter 120 can securely communicate with each other.

As described above, conventionally, when multiple wireless communication devices start ad-hoc network connections with the same wireless parameters (the same ESSID and the same channel) at the same time, each wireless communication device searches for peripheral wireless networks (probe request) at the same time. At this stage, because no ad-hoc network exists, responses (probe responses) from wireless communication devices cannot be obtained. Accordingly, each wireless communication device creates its own ad-hoc network and communication might not be carried out.

Further, if the wireless communication device itself creates the ad-hoc network, the wireless communication device has to regularly send a synchronization signal (beacon) even if there is no wireless communication device to communicate with, resulting in an increase in electric power consumption. In battery-powered wireless communication devices, this is wasteful consumption of battery power.

According to the present exemplary embodiment, a wireless communication device in a wireless system is equipped with an ad-hoc network establishing function, i.e., creator function, while other wireless devices are not equipped with the ad-hoc network establishing function. Accordingly, the wireless communication device with the creator function always creates an ad-hoc network and the other wireless communication devices join the established ad-hoc network to carry out wireless communication.

Accordingly, even if a plurality of wireless communication devices start wireless connections at the same time, it is possible to avoid the problem that each wireless communication device creates its own ad-hoc network and the different wireless communication devices cannot communicate with each other. Thus, the wireless communication devices can be securely connected to the same ad-hoc network and can communicate with each other.

Further, it is possible to determine the wireless communication device that has the creator function at the time of setting wireless parameters based on an electric power source configuration of each wireless communication device. Therefore, a wireless communication device that has access to ample electrical power, i.e., powered by an AC power source, will be given the creator function. As such, wireless communication devices with access to ample electrical power can form ad-hoc networks and regularly send a beacon signal that other wireless communication devices can use to connect to the ad-hoc network.

As indicated above, in battery-powered wireless communication devices, regularly sending a beacon signal drains battery power. In order to prevent this, battery-powered wireless communication devices can be set so as to not to have the creator function. By doing so, the battery-powered wireless communication devices are prevented from continuously sending beacon signals, and thus preventing unnecessary consumption of battery power.

In the first exemplary embodiment, at the time of wireless parameter setting, it is determined whether to equip a wireless communication device with the creator function based on the power source configuration (i.e., whether the wireless communication device is powered by a battery or an AC power source). However, it can be determined whether to equip the wireless communication device with the creator function based on remaining battery levels.

Further, instead of equipping a wireless communication device with the creator function at the time of setting wireless parameters, setting the creator function can be made in advance before the wireless communication device is shipped from the factory. The present exemplary embodiment can be applied to any wireless communication device which has a wireless LAN function, and is not limited to the digital camera 110 and the wireless adapter 120.

### Second Exemplary Embodiment

In the second exemplary embodiment, description of elements similar to the first exemplary embodiment is not repeated. For example, a configuration according to the second exemplary embodiment which includes the digital camera 110, the wireless adapter 120, and a printer 130 is similar to that described in the first exemplary embodiment, and the description of the configuration is omitted herein.

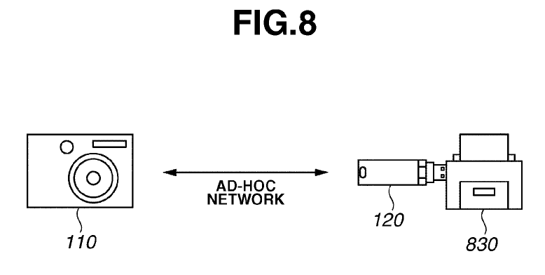

FIG. 8 illustrates a wireless communication system according to the second exemplary embodiment. A network includes the digital camera 110, which includes a wireless communication function, a wireless adapter 120, which includes a wireless communication function, and a printer 830. The wireless adapter 120 is connected to the printer 830 via a USB interface, to the digital camera 110 via a wireless LAN, and converts protocols between the USB and the wireless LAN. The printer 830 and the digital camera 110 are powered by batteries and the wireless adapter 120 is powered by the printer 830 via the USB.

Configurations of the digital camera 110, the wireless adapter 120, and the printer 830 are similar to those described in the first exemplary embodiment, and the same as shown in FIGS. 2, 3, and 4 respectively. Thus, detailed descriptions are omitted herein.

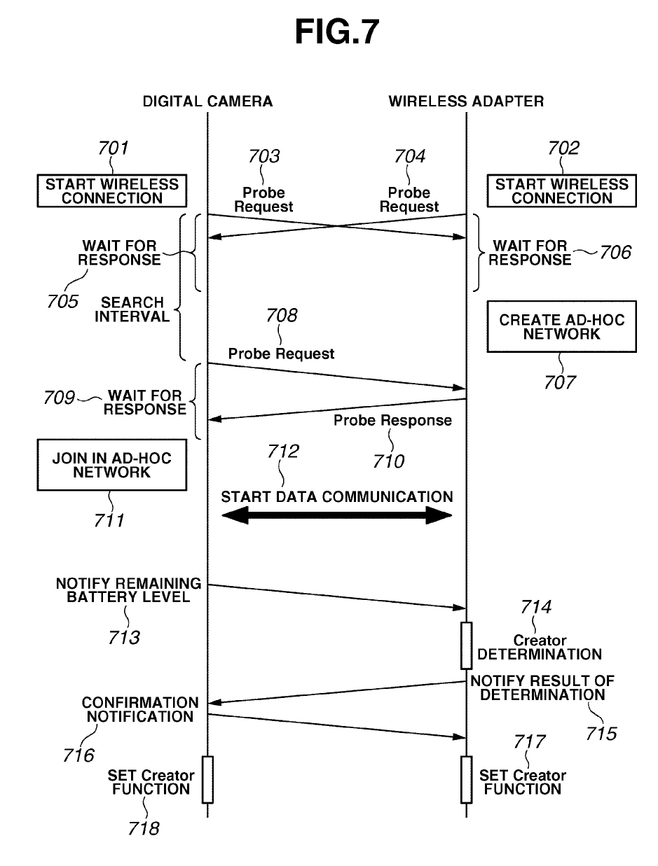

FIG. 7 illustrates a sequence of processing according to the second exemplary embodiment. The second exemplary embodiment is different from the first exemplary embodiment in that, after a wireless communication device is wirelessly connected to an ad-hoc network, wireless communication devices in the network negotiate to determine the wireless communication device which should be the wireless communication device equipped with the creator function.

First, after an ad-hoc network connection is carried out according to a procedure similar to the first exemplary embodiment (steps 701 to 710), it is automatically determined, based on electric power supplying methods or remaining battery levels, among the wireless communication devices which wireless communication device is to be the wireless communication device equipped with the creator function at the time of next connection.

In the second exemplary embodiment, the digital camera 110 and the wireless adapter 120 constitute an ad-hoc network. The second exemplary embodiment relates to a sequence carried out in a wireless connection when a direct printing is performed between the digital camera 110 and the printer 830 via wireless adapter 120, and more particularly, to a sequence carried out when an ad-hoc network is established.

Each wireless communication device in this system is divided into two types: a wireless communication device equipped with the ad-hoc network establishing function or a wireless communication device not equipped with the ad-hoc network establishing function. In the second exemplary embodiment, the wireless communication device equipped with the ad-hoc network is referred to as a wireless communication device with creator function.

If the wireless communication device with creator function creates an ad-hoc network and is the only wireless communication device in the network, the wireless communication device has to regularly send a beacon signal, as described above, which other wireless communication devices can use to join the ad-hoc network.

Accordingly, wireless communication device utilized electric power even though wireless data communication is not being carried out. Therefore, in this system, at the time of wireless parameter setting, a user, taking into consideration each wireless communication device's electric power supply method, designates a wireless communication device in the wireless system as a wireless communication device equipped with creator function. The other wireless communication devices are designated as wireless communication devices that are not equipped with creator function.

In the wireless system according to the second exemplary embodiment, at the time of wireless parameter setting, the wireless adapter 120 is designated as the wireless communication device equipped with creator function and the digital camera 110 is designated as the wireless communication device not equipped with creator function.

With reference to FIG. 7, specific operations in the second exemplary embodiment will be described. After wireless parameters are set, a first wireless connection sequence is carried out according to a sequence similar to that described in the first exemplary embodiment. The digital camera 110 joins an ad-hoc network according to the sequence described in the first exemplary embodiment (step 711), and data communication is started between the digital camera 110 and the wireless adapter 120 (step 712).

Then, the digital camera 110, which is the wireless communication device not equipped with creator function, notifies the wireless adapter 120, which is the wireless communication device equipped with the creator function, of the digital camera's 110 remaining battery level (step 713).

The wireless adapter 120 compares the received remaining battery level of the digital camera 110 with that of the wireless adapter 120, and determines which wireless communication device should be set as the wireless communication device equipped with creator function at the next connection (step 714). Then, the wireless adapter 120 notifies the result of the determination to the digital camera 110 (step 715).

When the digital camera 110 receives the result of the determination, a confirmation is notified to the wireless adapter 120 (step 716). Then, the digital camera 110 changes its own creator setting to the setting according to the determination result notification (step 715) at step 718.

When the confirmation notification is received (step 716), the wireless adapter 120 sets its own creator setting (step 717) according to the result determined at step 714. Then, the digital camera 110 carries out direct printing with the printer 830 through the wireless adapter 120.

In the subsequent wireless connection, the wireless communication device determined to be the wireless communication device with creator function (steps 717 and 718) operates as the wireless communication device with creator function to start a wireless connection. After the data communication is started (step 712), steps 713 to 718 are carried out again. Then, at the time of establishing the next connection, which wireless communication device should be a wireless communication device with creator function is determined.

If a plurality of wireless communication devices which are equipped with the creator function exist in the wireless system, the search of peripheral networks is regularly carried out after the wireless network is established. If a network which has the same wireless parameters is detected by the search, the established wireless network is abandoned. Then, by connecting to the detected network again, it is possible to connect to the same ad-hoc network and the plurality of wireless communication devices can communicate with each other.

As described above, conventionally, when multiple wireless communication devices start an ad-hoc network connection at the same time, with the same parameters (the same ESSID and the same channel), each wireless communication device starts the search of peripheral wireless networks (Probe Request) at the same time.

At this stage, no ad-hoc network exists, and therefore, no response (Probe Response) can be obtained from any other wireless communication device. Accordingly, each wireless communication device creates its own independent ad-hoc network and might not possibly communicate with each other.

Further, if the wireless communication device itself creates an ad-hoc network, even though there is no other wireless communication device to communicate with, the wireless communication device has to regularly send a beacon signal. Accordingly, consumption of electric power by the wireless communication device increases, and with respect to battery-powered wireless communication devices, this is wasteful consumption of battery power.

However, according to the second exemplary embodiment, one wireless communication device in the wireless system has the ad-hoc network establishing function and the other wireless communication devices do not have the ad-hoc network establishing function.

In the second exemplary embodiment, the wireless device equipped with the creator function always creates the ad-hoc network and the other wireless communication devices join the established ad-hoc network and are then able to carry out wireless communication.

Accordingly, even if a plurality of wireless communication devices start wireless connections at the same time, the problem that each wireless communication device creates its own ad-hoc network and the wireless devices cannot communicate with each other can be prevented. Therefore, the wireless communication devices can be securely connected to the same ad-hoc network and can communicate with each other.

Further, it is possible to determine, based on the electric power source configuration of each wireless communication device, at the time wireless parameters are set which wireless communication device should be the wireless communication device equipped with the creator function. Further, after a wireless connection is established, the remaining battery levels of the wireless communication devices are compared.

In addition, it is possible to dynamically determine the wireless communication device that should be the wireless communication device equipped with creator function at the next connection. Accordingly, a creator function can be adequately set in consideration of the remaining battery level of each wireless communication device. Therefore, a wireless communication device which has large remaining battery capacity creates an ad-hoc network and continues to regularly send a beacon signal for other wireless communication devices which are connected later so that a wireless communication device with a smaller remaining battery capacity does not consume battery power by sending the beacon signal even though there are no other wireless communication devices to communicate with in the ad-hoc network.

In the second exemplary embodiment, the decision regarding the creator function is based on the remaining battery level of the wireless communication devices at the time of next connection. However, the present invention is not limited to this embodiment, and the decision can be made based on the electric power source configurations (e.g., battery-powered or AC) of the wireless communication devices.

Further, in addition to the digital camera 110, the second exemplary embodiment, as well as the first exemplary embodiment, can be implemented using any device which functions as a digital camera, such as a digital video camera, a digital camera equipped cell phone, or the like.

### Other Exemplary Embodiments

Each unit which constitutes the wireless communication device, the control methods of the wireless communication device, and each step in the control methods in the wireless communication system according to the above-described exemplary embodiments can also be implemented according to a computer program stored on a RAM or a ROM of a computer. In this case, the computer program and the computer-readable recording medium on which the computer program is recorded constitute the present invention.

In the exemplary embodiments of the present invention, a computer in the system or the device (CPU or MPU) is directly or remotely provided with the computer program which implements the function of the above-described exemplary embodiments. In this case, the present invention can be achieved when the computer in the system or the device reads and implements the provided computer program.

Accordingly, the computer program itself installed onto the computer to implement the function and the processing of the exemplary embodiments of the present invention, can implement the present invention.

In this case, if the functions of the computer program are performed, an object code, a program implemented by an interpreter, or a script data to be provided to an operating system (OS) can also be used.

As the recording medium for providing such program, a floppy disk, a hard disk, an optical disk, a magneto-optical disk, a MO, a CD-ROM, a CD-R, a CD-RW and the like can be used. Further, a magnetic tape, a nonvolatile memory card, a ROM, a DVD (DVD-ROM, DVD-R) and the like can also be used.

As another method for providing the program, there is a method of accessing a website on the Internet by using a browser of a client computer, and downloading the computer program itself according to the present invention or a compressed file which includes an automatic installation function, from the website onto a recording medium such as a hard disk.

Further, the present invention can be achieved by dividing the computer program which constitutes the computer program according to the present invention into a plurality of files and downloading each divided file from different websites. That is, WWW servers or FTP servers which allow a plurality of users to download the program files for realizing the functional processing according to the present invention by using a computer are included in the present invention.

Further, the computer program according to the present invention can be encrypted, stored on a storage medium such as a CD-ROM and distributed to users. Users who satisfied predetermined conditions are allowed to download information about a key to decrypt, from a website through the Internet. Then, by using the downloaded key information, the encrypted program is decrypted and the decrypted computer program can be installed and carried out on a computer, and the present invention can be implemented.

Further, by carrying out the computer program read by the computer from a storage medium, the functions according to the above-described exemplary embodiments are implemented. Further, according to the instructions of the program, an OS operating on the computer carries out a part or all of the actual processing, and by carrying out the processing, the functions according to the above-described exemplary embodiments can be implemented.

Further, the computer program read from a recording medium is written onto a memory provided in a function enhancement board inserted into the computer or a function enhancement unit connected to the computer. Then, according to the instruction of the computer program, a CPU provided in the function enhancement board or the function enhancement unit carries out a part or all of the actual processing, and by carrying out the processing, the functions according to the above-described exemplary embodiments can also be implemented.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application 2005-265925 filed on Sep. 13, 2005, which is hereby incorporated by reference herein in its entirety.

What is claimed is:

1. A wireless communication apparatus having first wireless settings, comprising:
a search unit which searches for a device which has second wireless settings corresponding to the first wireless settings; and
a control unit which controls the wireless communication apparatus,
wherein if the device is found by the search unit and the device has not created an ad-hoc network, the control unit controls the wireless communication apparatus to create an ad-hoc network which includes the device and the wireless communication apparatus, and
wherein if the device is found by the search unit and the device has created an ad-hoc network, the control unit controls the wireless communication apparatus to join the ad-hoc network which has been created by the device.

2. A wireless communication apparatus according to claim 1, further comprising a setting unit which sets whether the control unit can control the wireless communication apparatus to create an ad-hoc network.

3. A wireless communication apparatus according to claim 2, wherein the setting unit sets whether the control unit can control the wireless apparatus to create an ad-hoc network based on an electric power source of the wireless communication apparatus.

4. A wireless communication apparatus having first wireless settings, comprising:
a search unit which searches for a device which has second wireless settings corresponding to the first wireless settings; and
a control unit which controls the wireless communication apparatus,
wherein if the device is found by the search unit, the control unit controls the wireless communication apparatus to create an ad-hoc network which includes the device and the wireless communication apparatus, and
wherein if the device is not found by the search unit, the control unit controls the search unit to continue to search for device which has the second wireless settings.

5. A wireless communication apparatus according to claim 4, further comprising a setting unit which sets whether the control unit can control the wireless communication apparatus to create an ad-hoc network.

6. A wireless communication apparatus according to claim 5, wherein the setting unit sets whether the control unit can control the wireless apparatus to create an ad-hoc network based on an electric power source of the wireless communication apparatus.

7. A method for controling a wireless communication apparatus having first wireless settings, the method comprising:
searching for a device which has second wireless settings corresponding to the first wireless settings;
controlling the wireless communication apparatus to, if the device is found and the device has not created an ad-hoc network, create an ad-hoc network which includes the device and the wireless communication apparatus; and
controlling the wireless communication apparatus to, if the device is found and the device has created an ad-hoc network, join the ad-hoc network which has been created by the device.

8. A method according to claim 7, further comprising setting whether the wireless communication apparatus can create an ad-hoc network.

9. A method according to claim 8, wherein setting whether the wireless apparatus can create an ad-hoc network is based on an electric power source of the wireless communication apparatus.

10. A computer-readable storage medium which stores computer program for causing a computer to execute the method of claim 7.

11. A method for controling a wireless communication apparatus having first wireless settings, the method comprising:
searching for a device which has second wireless settings corresponding to the first wireless settings;
controlling the wireless communication apparatus to, if the device is found, create an ad-hoc network which includes the device and the wireless communication apparatus; and
controlling the wireless communication apparatus to, if the device is not found, continue to search for the device which has the second wireless settings.

12. A method according to claim 11, further comprising setting whether the wireless communication apparatus can create an ad-hoc network.

13. A method according to claim 12, wherein setting whether the wireless apparatus can create an ad-hoc network is based on an electric power source of the wireless communication apparatus

14. A computer-readable storage medium which stores computer program for causing a computer to execute the method of claim 11.
